(19) United States
(12) Patent Application Publication
(10) Pub. No.: US 2017/0246640 A1
(43) Pub. Date: Aug. 31, 2017

(54) APPARATUS FOR DESTROYING DIGITAL MEDIA STORAGE DEVICES

(71) Applicant: ALLEGHENY PAPER SHREDDERS CORPORATION, DELMONT, PA (US)

(72) Inventors: JAMES WAGNER, HARRISON CITY, PA (US); THOMAS WAGNER, MURRYSVILLE, PA (US); RICHARD D. CERRA, ACME, PA (US); ANDY CIESIELSKI, GREENSBURG, PA (US); STAN CIESIELSKI, IRWIN, PA (US); SCOTT HAUSER, LATROBE, PA (US)

(73) Assignee: ALLEGHENY PAPER SHREDDERS CORPORATION, DELMONT, PA (US)

(21) Appl. No.: 15/053,224

(22) Filed: Feb. 25, 2016

(51) Int. Cl. B02C 18/14; B02C 13/284; B02C 21/02; B02C 13/31; B02C 18/22; B02C 13/04; B02C 13/286

(52) U.S. Cl. CPC B02C 18/142; B02C 13/04; B02C 13/284; B02C 13/286; B02C 13/31; B02C 18/2216; B02C 21/02; B02C 2013/28672; B02C 2018/147

(57) ABSTRACT

An apparatus for destroying data storage devices comprises a shredder assembly, a hammer mill assembly, a chute mounted in an open communication with an interior of the shredder assembly and with an interior of the hammer mill assembly, the chute sized and shaped to transfer shredded remnants from the shredder assembly into the hammer mill assembly, a power drive assembly coupled to each of the shredder assembly and the hammer mill assembly, and a control assembly configured to operate the shredder assembly and the hammer mill assembly.

### CROSS-REFERENCE TO RELATED APPLICATIONS

N/A

### STATEMENT REGARDING FEDERALLY SPONSORED RESEARCH AND DEVELOPMENT

N/A

### REFERENCE TO SEQUENCE LISTING, A TABLE, OR A COMPUTER PROGRAM LISTING COMPACT DISC APPENDIX

N/A

### BACKGROUND

1. Technical Field

The subject matter relates to a destruction of data storage devices. The subject matter may also relate to a destruction of digital media storage devices used for storage and retrieval of digital information.

2. Description of Related Art

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Destruction of digital media storage devices, for example such as hard drives, may be a subject to regulatory requirements, as well as business safety and security practices and expectations. Of a particular interest may be a destruction of the hard drives in a manner that prevents subsequent retrieval of data from remnants thereof. By way of a non-limiting example, Notational Security Agency (NSA) may mandate that a size of each remnant of the destroyed hard drive does not exceed a size of two (2) millimeters.

Although previous efforts have employed a grinding method to destroy the digital media storage devices, as for examples disclosed in U.S. Pat. No. 8,251,303 issued to Wozny on Aug. 28, 2012 or in the applicant's prior application published as US PUB. No. 2015-0336105 A1 on Nov. 26, 2015, there is a need for an improved apparatus, directed to at least increasing production rates and resolving problems associated with undesirable heat generated during grinding of digital media storage devices containing aluminum material.

### BRIEF DESCRIPTION OF THE DRAWINGS

The accompanying drawings are incorporated in and constitute part of the specification and illustrate various embodiments. In the drawings:

FIG. 1 illustrates a front diagrammatic view of an embodiment of an apparatus configured to destroy data storage devices;

FIG. 2 illustrates a side diagrammatic view of the apparatus of FIG. 1;

FIG. 3 illustrates a perspective view of mounting frame members and an embodiment of a hammer mill housing employed in the apparatus of FIGS. 1-2;

FIG. 4 illustrates a partial perspective view of an embodiment of a hammer mill assembly employed in the apparatus of FIG. 1-2 or 7-11, particularly illustrating such hammer mill housing in a closed position;

FIG. 5 illustrates a partial perspective view of the hammer mill assembly of FIG. 4, being in an open position;

FIG. 5A illustrates a partial enlarged view of the upper edge of the lower portions of the hammer mill assembly of FIG. 5;

FIG. 6 illustrates a partial perspective view of the hammer mill assembly of FIG. 5, with hammers disposed in a lower portion of the hammer mill housing when the upper portions are pivoted into open position;

FIG. 7 illustrates a partial perspective view of the hammer mill housing of FIG. 5, with hammers disposed in upper portions of the hammer mill housing being pivoted into open position;

FIG. 8 illustrates a front view an embodiment of an apparatus configured to destroy data storage devices;

FIG. 9 illustrates a side view of the apparatus of FIG. 8;

FIG. 10 illustrates a front view an embodiment of an apparatus configured to destroy data storage devices;

FIG. 11 illustrates a side view of the apparatus of FIG. 10;

FIG. 12 illustrates a partial perspective view of an embodiment of a hammer mill assembly that can be employed in apparatus of FIGS. 1-2 and 8-11;

FIG. 13 illustrates an exemplary schematic control diagram of the apparatus of FIGS. 1-12; and

FIG. 14 illustrates a flow chart of an exemplary process for destroying data storage devices.

### DETAILED DESCRIPTION OF EXEMPLARY EMBODIMENTS

Prior to proceeding to the more detailed description of the present invention, it should be noted that, for the sake of clarity and understanding, identical components which have identical functions have been identified with identical reference numerals throughout the several views illustrated in the drawing figures.

The following detailed description is merely exemplary in nature and is not intended to limit the described examples or the application and uses of the described examples. As used herein, the words “example”, “exemplary” or “illustrative” means “serving as an example, instance, or illustration.” Any implementation described herein as “example”, “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the spatially relative terms “upper,” “lower,” “left,” “rear,” “right,” “front,” “vertical,” “horizontal,” “exterior,” “interior,” “beneath,” “below,” “above,” and the like, and derivatives thereof shall relate to the invention as oriented in the Figures and may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

Furthermore, there is no intention to be bound by any expressed or implied theory presented in the preceding technical field, background, or the following detailed description. It is also to be understood that the specific devices and processes illustrated in the attached drawings, and described in the following specification, are simply examples of the inventive concepts defined in the appended claims. Hence, specific dimensions and other physical characteristics relating to the examples disclosed herein are not to be considered as limiting, unless the claims expressly state otherwise.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The term “digital media storage device” should be broadly interpreted as referring to magnetic media, for example such as traditional laptop/computer hard drives, tapes, CDs, JAZ drives/disks, ZIP drives/disks; solid state media, such as solid state drives (SSD), flash drives, USB drives, thumb drives; optical media, such as CD-Roms and DVDs; hybrids, such as a combination of magnetic and solid state; microfilms; paper/plastic media, IDs and badges, memory chips and sticks; and even printed circuit board assemblies, mobile communication devices, such as cell phones, transmitters, pagers, notebooks, Ipads, tablets and the like.

The particular embodiments of the present disclosure generally provide apparatus and methods directed to destruction of digital media storage devices, hardcopy/paper containing classified information and paper/plastic based media devices, which are being referred further in this document as data storage device(s).

In particular embodiments, the apparatus and methods are directed to a destruction of digital media storage devices and paper or paper-based storage devices so that each remnant of the destroyed digital media storage device, paper or paper-based storage devices does not exceed a size of two (2) millimeters. Destruction should be broadly interpreted as referring to a damage to such data storage devices that the information, particularly of a classified nature, contained therewithin or thereon cannot be read, viewed or manipulated manually or electronically. Destruction should be also broadly interpreted herewithin as disintegration, or sanitization of data storage devices and the information contained therewithin or thereon.

In an embodiment, the apparatus comprises a dual shredder assembly defining a first stage and a dual hammer mill assembly defining a second stage of the destruction process.

In an embodiment, the apparatus comprises a single cross-cut shredder assembly defining a first stage and a single hammer mill assembly a second stage of the destruction process.

In an embodiment, the apparatus comprises a dual shredder assembly defining a first stage and a single hammer mill assembly defining a second stage of the destruction process.

In an embodiment, the apparatus comprises a cross-cut shredder assembly defining a first stage and a dual hammer mill assembly defining a second stage of the destruction process.

In all embodiments, the shredder assembly is positioned and operable, in the destruction process, before the hammer mill assembly.

For the sake of brevity, the description and/or illustration of most if not all holes and fasteners required to fasten components to each other, either directly or indirectly, is omitted in this document.

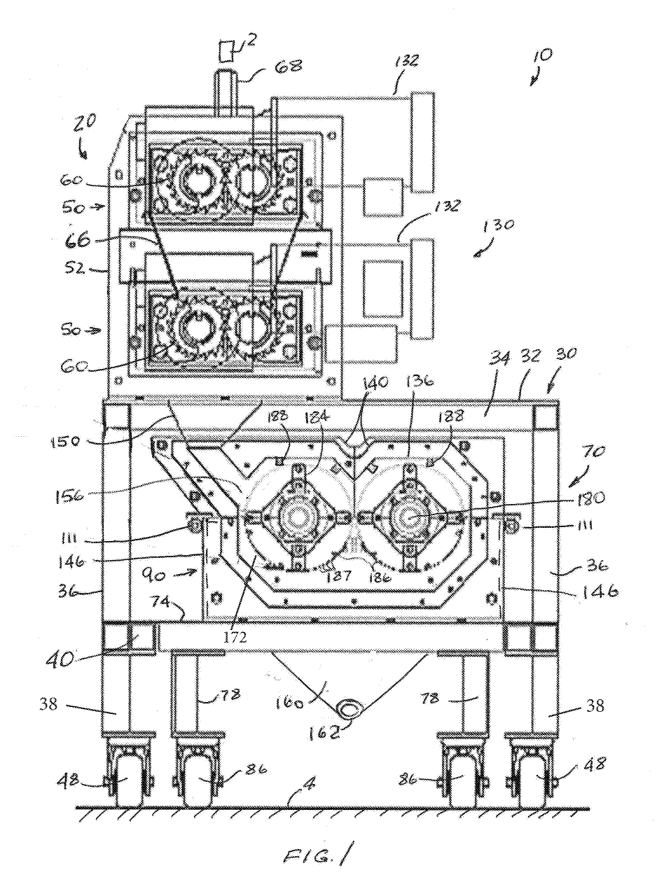

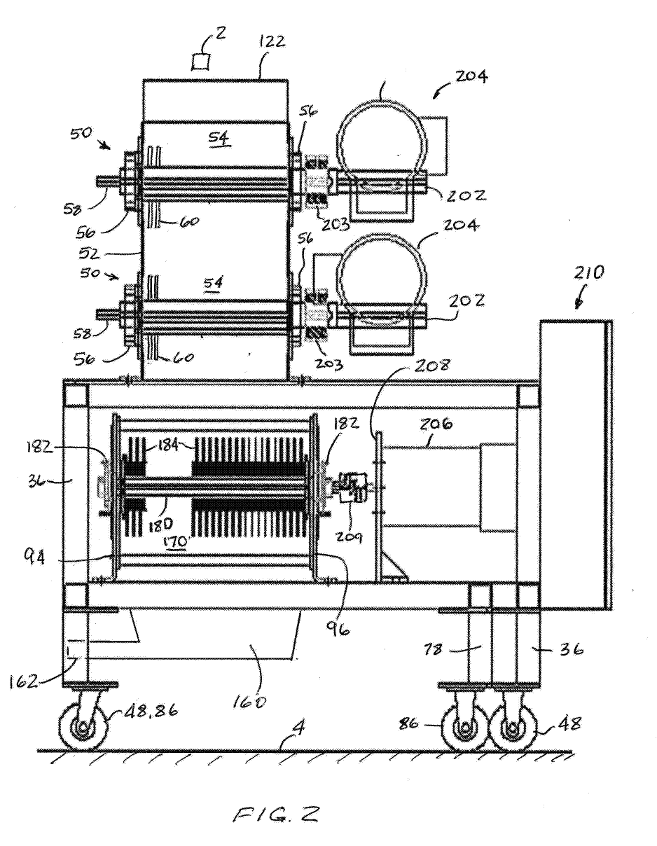

Now in reference to FIGS. 1-6, therein is illustrated an embodiment of the apparatus 10 for destroying data storage devices, such as digital media storage devices, paper and paper/plastic-based storage devices. The apparatus 10 comprises a dual shredder assembly 20 defining a first phase or stage of a destruction process, a dual hammer mill assembly 70 defining a second phase or stage of the destruction process, a power drive assembly 200 and a control assembly 210.

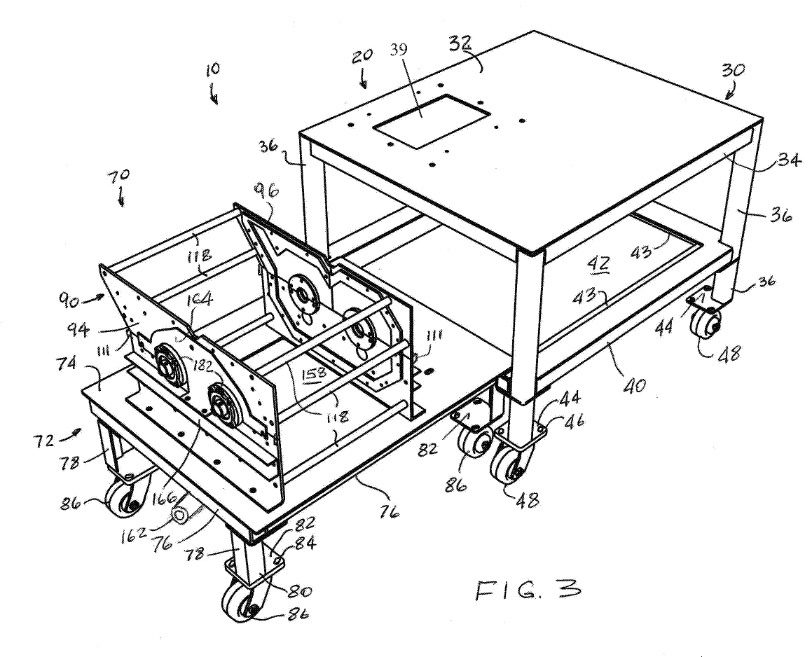

The dual shredder assembly 20 comprises a mounting frame member 30. The mounting frame member 30 comprises a top member 32 that is being best illustrated in FIG. 3 as being a generally sold member substantially closing a top of the mounting frame member 30. The top member 32 may be also provided as an open member. For example, the top member 32 may be comprised only of the upper supports, braces or flanges 34. In one form, the mounting frame member 30 comprises vertical members 36 that are spaced apart from each other to support the top member 32 during use of the apparatus 10. In this form, the mounting frame member 30 may also comprise a bottom member 40 that can be provided as a closed member with a continuous surface or as an open member, for example as having a U-shaped configuration with an opening 42, as is best illustrated in FIG. 3. In one form, the top member 32 may be positioned at a ground level or surface 4, eliminating the need for vertical members 36. In one form, the top member 32 may be provided by a ground surface 4 itself. The top member 32 may also comprise opening 39 formed through a thickness thereof.

The dual shredder assembly 20 can be provided as a stationary member. In one form, the bottom end 38 of each vertical member 36 may be simply rested on a surface, for example such as a ground surface 4. In one form, the bottom end 38 of each vertical member 36 may be adapted with a flange 44 configured to rest on a horizontal surface (not shown). In one form, the bottom end 38 of each vertical member 36 may be adapted with a flange 44 configured to be fastened (in place) thereto by way of apertures 46. In one form, the top member 32 may be disposed on and even be fastened to the ground surface 4 itself (or any other surface or support), eliminating the need for vertical members 36. The dual shredder assembly 20 can be also provided as a portable or movable member. In this form, each bottom end of the vertical members 36 is configured to securely receive wheels or casters 48. In one form, a flange of each wheel or caster 48 can be fastened to the above described flange 44 by way of apertures 46 and fasteners (not shown) that could be simply threaded fasteners (not shown).

The dual shredder assembly 20 further comprises a pair of cross-cut shredders 50 mounted in a vertical tandem arrangement with one another. Each of the pair of cross-cut shredders 50 comprises a shredder housing 52 having a hollow interior 54. A pair of shredder rotors 58 of each cross-cut shredder 50 are mounted in a horizontal tandem arrangement with one another and for a rotation within the hollow interior 54 of the shredder housing 52. In other words, in cross-cut shredders 50 are vertically stacked in this embodiment. Bearing supports 56 may be provided on opposite walls of the shredder housing 52 to receive ends of the shredder rotors 58. Cutters 60 are mounted on each of the pair of shredder rotors 58 for the rotation therewith. In one form, the cutters 60 overlap one another during the rotation. In one form, the cutters 60 in the upper cross-cut shredders 50 may be provided as being about 0.25″ in width and about 4.88″ in diameter. In one form, the cutters 60 in the upper cross-cut shredders 50 may be provided as being about 0.31″ in width and about 4.88″ in diameter. In one form, the cutters 60 in the upper cross-cut shredders 50 may be provided as being between about 0.25″ wide and about 0.5″ wide. The cutters 60 in the upper cross-cut shredders 50 may be spaced from each other along a length of the rotor 58 at a distance of about 0.25 inches. In one form, the cutters 60 in the lower cross-cut shredders 50 may be also provided as being about 0.25″ in width and about 4.88″ in diameter. In one form, the cutters 60 in the lower cross-cut shredders 50 may be also provided as being about 0.12″ in width and about 4.88″ in diameter. In one form, the cutters 60 in the lower cross-cut shredders 50 may be provided as being between about 0.12″ wide and about 0.5″ wide. The cutters 60 in the lower cross-cut shredders 50 may be also spaced from each other along a length of the rotor 58 at a distance of about 0.25″. The cutters 60 in one or both the upper and lower cross-cut shredders 50 may be of different diameters.

In one form, the cutters 60 in each of the upper and lower cross-cut shredders 50 are stacked to avoid having all of the “piercing” points contact or hit the data storage devices 2 or remnants thereof at once. In one form, the cutters 60 are staggered so that there are at least 4 positions and that each cutter 60 contacts or hits the data storage devices 2 or remnants thereof at a separate point in the rotation.

A passageway 66 is defined between shredder housings 52 in an open communication therewith so as to communicate the shredded remnants of the data storage device 2 from the upper cross-cut shredder 50 to the lower cross-cut shredder 50 for additional shredding. Passageway 66 essentially defines a hollow member sized and spaced to allow passage of the shredded remnants from the upper cross-cut shredders 50 to the lower upper cross-cut shredders 50. However, in an embodiment, upper and lower housings 52 can be provided as a single housing member, wherein the passageway 66 is essentially a portion of the hollow interior of such single housing 52 and wherein the cross-cut shredders 50 are mounted at a distance from each other in a vertical direction so that the cutters 60 in the upper cross-cut shredder 50 do not touch or overlap with the cutters 60 in the lower cross-cut shredder 50.

It is also contemplated herewithin that the shredder housing(s) 52 can be disposed directly on the ground surface 4.

A hollow chute 68 is mounted above the upper shredder housing 52 so as to pass the data storage device 2 to be destroyed into the dual shredder assembly 20.

In one form, upper cross-cut shredders 50 may be configured so that the width of the shredded remnant from the upper cross-cut shredders 50 is about 0.25″ and the length of the shredded remnant from the upper cross-cut shredders 50 is about 0.88″ or greater. The width of the shredded remnant from the lower cross-cut shredders 50 may be about 0.25″. The length of the shredded remnant from the lower cross-cut shredders 50 may be about 0.25″ or greater.

The dual hammer mill assembly 70 comprises a mounting member or a mounting member 72. The mounting member 72 comprises a top member 74 that is being best illustrated in FIG. 3 as being a generally sold member substantially closing a top of the mounting member 74. The top member 74 may be also provided as an open member. For example, the top member 74 may be comprised only of the upper supports, braces or flanges 76. The mounting frame member 72 comprises vertical members 78 that are spaced apart from each other to support the top member 74 during use of the apparatus 10.

The dual hammer mill assembly 70 can be provided as a stationary member. In one form, the bottom end 80 of each vertical member 78 may be simply rested on a surface, for example such as a ground surface 4. In one form, the bottom end 80 of each vertical member 78 may be adapted with a flange 82 configured to rest on a horizontal surface (not shown). In one form, the bottom end 80 of each vertical member 78 may be adapted with a flange 82 configured to be fastened (in place) thereto by way of apertures 84. In one form, the top member 74 may be disposed on and even be fastened to the ground surface 4 itself. The dual hammer mill assembly 70 can be also provided as a portable or movable member. In this form, each bottom end 80 of the vertical members 78 is configured to securely receive wheels or casters 86, which could be the same as above described wheels or casters 48. In one form, a flange of each wheel or caster 86 can be fastened to the flange 82 by way of apertures 46 and fasteners (not shown) that could be simply threaded fasteners.

In a more particular reference to FIGS. 3-7, the dual hammer mill assembly 70 also comprises a hammer mill housing 90 that upstands, during use of the apparatus 10, on the mounting member 72, although it is contemplated herewithin that the hammer mill housing 90 may upstand directly on the ground surface 4. The hammer mill housing 90 comprises a side wall 92. The side wall 92 may be a continuous side wall forming a hollow interior of the hammer mill housing 90. The side wall 92 may comprise a first member 94 and a second member 96 disposed in a vertical plane and being spaced apart from each other to define a depth of the hammer mill housing 90. Each of the first member 94 and the second member 96 comprises a pair of through apertures 98. Each of the apertures 98 in the first member 94 is aligned with a respective aperture 98 in the second member 96. Each aperture 98 can be adapted with a bore 100 of a larger diameter in the exterior surface of the respective one of the first member 94 and the second member 96 and being facing outwardly. The bore 100 may define left and right configurations of the first member 94 and the second member 96.

Otherwise, the first member 94 and the second member 96 are substantially identical. Two or more apertures 102 may be disposed external to the edge of each bore 100 in a radial pattern therewith. The apertures 102 may be through apertures and may be also provided as threaded apertures. In another form, the aperture 98 may be provided within a member 99 being rigidly attached, for example by welding or fastening, to the first member 94 or the second member 96 with the bores 100 being formed, as apertures, through thickness of the first member 94 or the second member 96.

Each of the first member 94 and the second member 96 can be either welded, at a bottom edge thereof, to the top surface 74 of the mounting member 72 or may be fastened thereto, for example, through an optional flange 104. The optional flanges 104 may be also used to attach the housing 90 directly to the ground surface 4. One or more optional braces 118, spanning the distance between the first member 94 and the second member 96, may be provided to enable rigidity of the hammer mill housing 90, particularly reinforcing the upper edges of the first member 94 and the second member 96.

In an embodiment, each of the first member 94 and the second member 96 is provided as a unitary one-piece member with or without the optional flange 104.

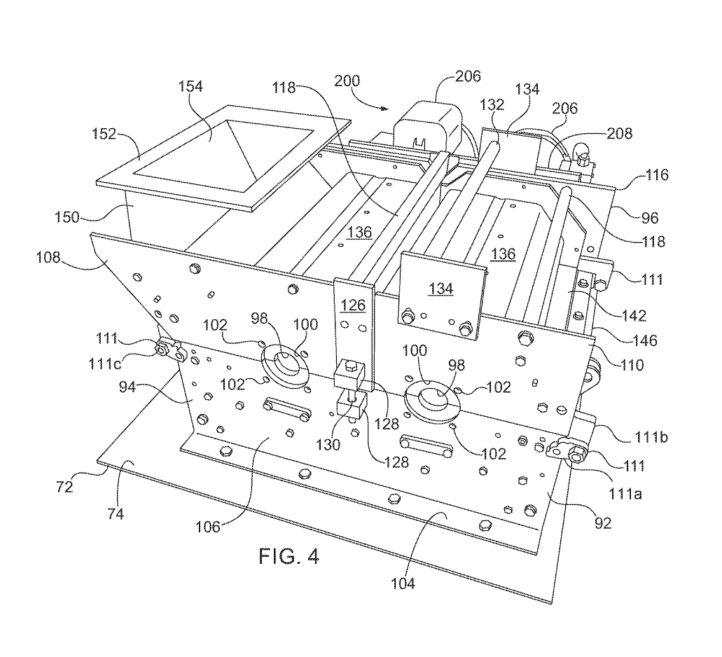

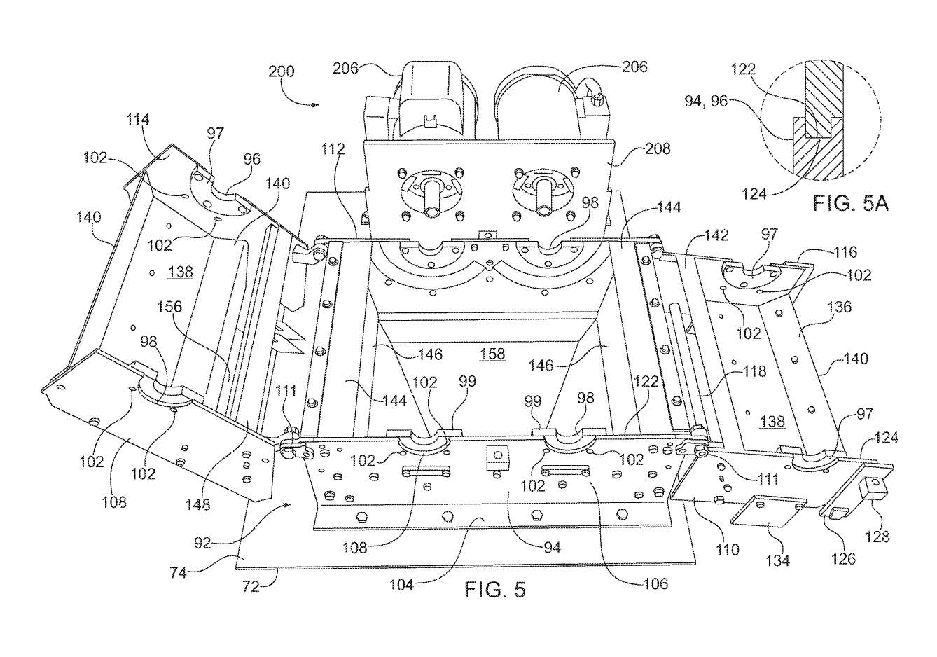

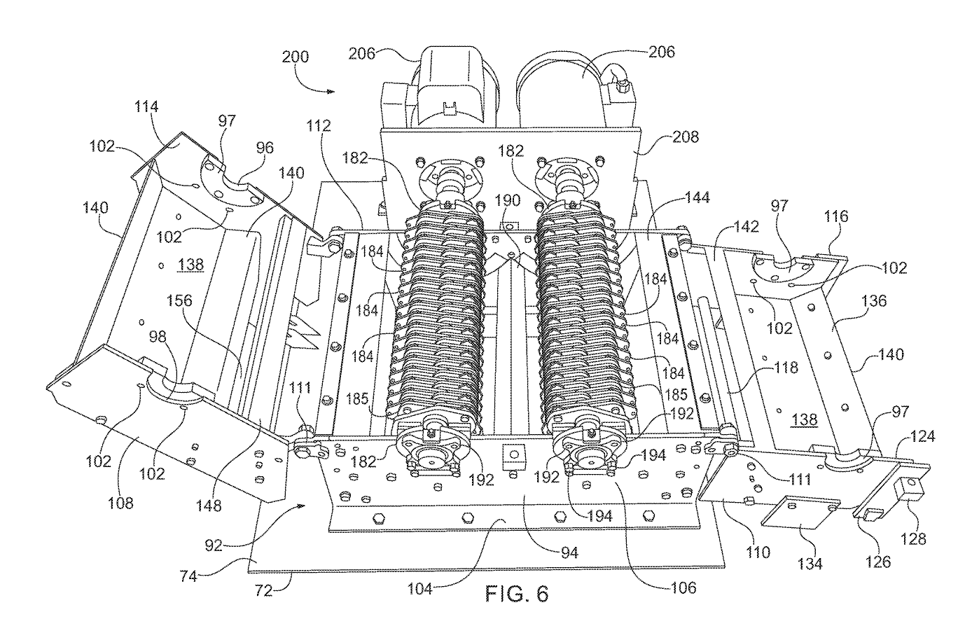

In an embodiment, the first member 94 is provided as comprising a lower portion 106 and a pair of upper portions 108 and 110, each pivotally coupled to the lower portion 106 with a pivot 111. Thus, in this embodiment, the upper portions 108 and 110 are movable between a closed operative position of FIGS. 3-4, wherein the inner edges of the upper portions 108 and 110 abut each other and the upper portions 108 and 110 being disposed in a contact with the lower portion 106 and being juxtaposed with each other to define one or more chambers of the hammer mill housing 90, and an open position of FIGS. 5-6, wherein the upper portions 108 and 110 are pivoted outwardly and away from each other.

Similarly, the second member 96 is provided in this embodiment as comprising a lower portion 112 and a pair of upper portions 114 and 116, each pivotally coupled to the lower portion 112, for example with the above described pivot 111. Thus, the upper portions 108, 110, 114 and 116 are movable between a closed operative position of FIGS. 3-4, wherein the inner edges of the upper portions 108 and 110 and 114 and 116 abut each other and the upper portions 108, 110, 114 and 116 being disposed in a contact with the lower portion 112 and being juxtaposed with each other to define one or more chambers of the hammer mill housing 90, and an open position of FIGS. 5-6, wherein the upper portions 108, 110, 114 and 116 are pivoted outwardly and away from each other.

In this embodiment, the apertures 98, the bores 100 and the apertures 102 are split between the lower portions 106 and 112 and the upper portions 108, 110, 114 and 116, as is best shown in FIGS. 4-7.

During operation of the apparatus 10, the pair of upper portions 108 and 110 and the pair of upper portions 114 and 116 are disposed in the closed position of FIGS. 3-4.

It is contemplated herein to seal at least the engagement between the lower and upper portions. In one form, each of the lower portions 106 and 112 may be adapted with a groove 122 and each of the upper portions 108, 110, 114 and 116 may be adapted with a complimentary tongue 124. The groove 122 and the tongue 124 do not have to be provided as continuous members or do not have to span the entire width of the lower portions 106 and 112. In one form, the groove 122 is shown in FIG. 5a as being in the middle of the thickness of the lower members 94, 96 and the tongue 124 is shown as being formed by an edge notch in the upper portions 108, 110, 114 and 116. In one form, the tongue 124 can be also formed in the middle of the thickness of the upper portions 108, 110, 114 and 116. In one form, the groove 122 can be provided as an edge notch, either internal or external, with the tongue 124 being provided as a complimentary edge notch in upper portions 108, 110, 114 and 116. In one form, the groove (or notch) 122 and the tongue (or notch) 124 can be reversed between the upper and lower portions. In another form of FIG. 3, a cover 164 may be provided to seal engagement between the lower portions 106, 112 and the upper portions 108, 110, 114 and 116, as well as engagement between inner edges of the mating upper portions 108, 110, and 114, 116. Such cover 164, when provided, will be rigidly secured, by welding or fastening, to one or more of the above described portions 106 and 108, 110, 112, 114 and 116 and may be also rigidly secured, by welding or fastening, to an optional support 166.

The stationary portion 111a of each pivot 111 may be securely coupled either to the lower portion 94 or 96 or the member 146. The movable portion 111b of each pivot 111 is securely coupled to a respective upper portion 108, 110, 114 or 116. The stationary and movable portions can be fastened to each other, for example with fastener(s) 111c.

Furthermore, the vertical seam between the inner edges of the upper portions 108 and 110 and the inner edges of the upper portions 114 and 116 can be sealed with a member 126 being rigidly attached, either by welding or fastening, to one of the upper portions, shown as upper portion 110.

To prevent unintended separation of the upper portions 108 and 110 with the lower portion 106 and the upper portions 114 and 116 with the lower portion 112, a pair of blocks 128 can be provided, in a vertical spaced apart relationship with each other on each of the first member 94 and the second member 96. One of the pair of blocks 128 is rigidly coupled to the lower portion 106 or 112, while the other one of the pair of blocks 128 is rigidly coupled to member 126. The pair of blocks 128 at each member 94 or 96 is connected under tension, during operation, by a bolt 130.

A handle 132 may be provided and coupled, with a pair of plates 134, for example, to upper portions 110 and 116.

Hammer mill housing 90 also includes top member 136. The top members 136 of the hammer mill housing 90 are securely attached, either by welding or fastening to opposite upper portions of the first member 94 and the second member 96. Each member 136 can be defined by a middle portion 138 that is disposed generally horizontally during operation of the apparatus 10 and a pair of end portions 140, each disposed at an incline to the middle portion 138. One of the end portions 140 is adapted with a flange 142 spanning the width between a pair of upper portions, referenced by numerals 110 and 116. During operation, a surface of the flange 142 is disposed in a contact with a surface of a flange 144 spanning a distance between the lower portions 106 and 112 and being connected to a member 146 spanning the distance between and being rigidly attached to the first member 94 and the second member 96 on the right side of the hammer mill housing 90. This contact seals one end of the housing 90, shown as a right end in FIGS. 4-6. The other end of the housing 90 is adapted with a hammer mill chute 150 defining an exterior flange 152 with an exterior or entry opening 154. In an embodiment, when the hammer mill assembly 70 is disposed under the shredder assembly 20, the opening 154 is aligned with the opening 39 in the top member 32. Furthermore, exterior flange 152 may be fastened to the top member 32. The hammer mill chute 150 also defines an interior opening 156, running along a member 148 and defining, in one form only, a narrow slot. The member 148 also contacts another flange 144 spanning the distance between the lower portions 106 and 112 and being connected to another member 146 spanning the distance between and being rigidly attached to the first member 94 and the second member 96 on the left side of the hammer mill housing 90.

In one form, the hammer mill chute 150 may be disposed on the right side of the hammer mill housing 90 with the flanges 142 and 144 being disposed on the left side of the hammer mill housing 90 when the shredder assembly is positioned to the right of the apparatus 10 of FIG. 1. In one form, the hammer mill chute 150 may be centered on the hammer mill housing 90, particularly when the first member 94 and the second member 96 are provided as unitary one-piece members. The size and shape of the openings 154 and 156 are not limiting factors of the apparatus 10.

In an embodiment, the bottom of the hammer mill housing 90 is generally open by an opening 158 formed through the thickness of the mounting member 72 so that remnants of the destroyed data storage devices can be collected within a receptacle 160 around the opening 158 and evacuated, for example by vacuuming, therefrom, for example through an outlet 162 by a suction apparatus (not shown) into a discharge container (not shown).

The hammer mill housing 90 may be manufactured, either partially or completely, from metal, plastics and a combination thereof. The components of the hammer mill housing 90 may be welded or fastened together. The hammer mill housing 90 may be manufactured by a casting or forging process and machined to incorporate required features, for examples such as holes needed for fastening various components together.

The dual hammer mill assembly 70 further comprises a pair of chambers 170 formed by a combination of the first member 94, the second member 96, members 146 and members 136. Each of the pair of chambers 170 has opposing elongated curved portions 172 defined at the bottom of each chamber 170. The above described members 136 define a top of each chamber 170. The chambers 170 are completed by the first and second members, 94 and 96 respectively, and the pair of members 146. Essentially, each chamber 170 is formed by a combination of the member 136 defining a top wall, the mounting member 72 defining a bottom wall, and the four side walls defined by members 94, 96 and 146, each of the pair of chambers 170 having opposing elongated curved portions defined in the bottom wall and tapered portions defined in the top wall, the curved portions and the tapered portions spanning a distance between two opposing walls and defining a passageway from one chamber to another chamber.

The curved portions 172 span the distance between the first and second members, 94 and 96 respectively, and defining a passageway 176 from one chamber 170 to another chamber 170 during operation of the hammer mill assembly 70. A pair of rotors 180 is also provided, with each of the pair of rotors 180 disposed within a respective one of the pair of chambers 170 and having ends thereof mounted for a rotation in the opposing respective apertures 98. Each end or the rotor 180 may be mounted for a rotation within a bearing mount 182 being partially disposed within the bore 100 and being secured, for example by fastening, to the apertures 102. Thus apertures 98 and 102 and bores 100 provide mounting provisions for rotors 180. Hammers 184 are mounted on each of the pair of rotors 180, wherein at least some of the hammers 184 being pivotally mounted, with ends of the hammers 184, when extended or fixed during rotation, describing a circle of a predetermined radius for each of the first and second rotors 180. In one form, each hammer 184 can be provided in a rectangular shape with sizes of about 0.88″ wide by about 1.88″ long by about 0.15 thick. In one form, each hammer 184 can be provided in a rectangular shape ranging in sizes between about 0.25″ wide by 0.5″ long by about 0.06″ thick and about 2.5″ wide by about 5.5″ long×about 0.75″ thick.

The hammers 184 are illustrated as being mounted in four positions: 0°, 90°, 180° and 270° on mounts 185. In one form, one to four hammers 184 can be mounted on a single mount 185. In one form, two hammers 184 can be mounted on a single mount 185. In one form, a single hammer 184 can be mounted on a single mount 185, with eight hammers 184 disposed in series at 0°, 90°, 180°, 270° 0°, 270°, 180° and 0°. In this form, the hammer mill 70 uses less hammers and provides more room for product to move around with increased side-to-side agitation.

A pair of screens 186 are provided within the dual hammer mill assembly 70, with each of the pair of screens 186 being disposed, between the opposing first and second members, 94 and 96 respectively, and essentially defining the above described curved portions 172 of the hammer mill housing 90. The curved screens 186 are mounted in a co-axial alignment with a respective one of the pair of rotors 180. Although it is also contemplated herein that one or both screens 186 can be flat. A member 190 may be provided mediate the members 146 of the housing 90 to couple, either releaseably or permanently, one long edge of each screen 186. The opposite long edge of each screen 186 can be coupled, either releaseably or permanently, to the interior surface of the member 146. Although it is also contemplated herewithin that two screens 186 can be provided as a single unitary member. Each screen 186 has apertures 187 formed through a thickness thereof. The size and shape of screen apertures 187 and their pattern within the screen 186 varies depending on the type of data storage device 2 and the resulting particle size. When such application is directed to destruction of solid state hard drives and meeting NSA requirement of 2 millimeters (mm), the screen apertures 187 may be provided as having round shape with about 0.065 inches in diameter and being spaced apart from each other in an orthogonal grid configuration at a distance of 0.096 inches.

The hammer mill assembly 70 may comprise optional baffles or breaker bars 188 spanning, partially or completely, the distance between the opposing first and second members, 94 and 96 respectively. In one form, the baffles or breaker bars 188 can be mounted only to inner surface of the member 136. In one form, the baffles or breaker bars 188 can be mounted to the screens 186. In one form, the baffles 188 can be mounted to both members 136 and screens 186. Although the baffles or breaker bars 188 are shown as continuous elongated member, they can be also provided as spaced apart members or abutments. The baffles or breaker bars 188 are configured and operable to agitate the shredded remnants and disrupt flow of the remnants within the chamber 100, thus assisting in breaking material down as it is being processed through the hammer mill assembly 70.

When the hammer mill housing 90 is provided as comprising the lower portions 106 and 112 and the upper portions 108, 110, 114 and 116, the rotors 180 with hammers 184 can be easily removed from the hammer mill housing 90 for maintenance or replacement purposes by simply pivoting the upper portions 108, 110, 114 and 116, into the second position.

The chambers 170 may be also formed by a peripheral side wall 92 of a unitary construction and the top members 136.

In one form, it is further illustrated in FIG. 6 that the hammers 184 and their rotors 180 can remain in the lower portions 106, 112 when the upper portions 108, 110, 114 and 116. In this form, the bearing mounts 182 may remain fastened in place to the lower potions 106, 112 with fasteners 194. The upper portions 108, 110, 114 and 116 can be then pivoted into the second position by removing fasteners 194 passed through upper pair of apertures 192 in each bearing mount 182. In one form, the lower pair of fasteners 194 may be removed so that the rotors 180 remain fastened to the upper portions 108, 110, 114 and 116 and pivot outwardly therewith.

The power drive assembly 200 comprises a pair of gearbox assemblies 202, each coupled to one of the pair of shredder rotors 58. The gearbox assembly can be of a model 0230-30524 type, manufactured by a Hub City, Inc., a wholly owned subsidiary of Regal-Beloit Corporation of Beloit, Wis. The gearbox assembly 202 may be coupled with an optional coupling 203. A first pair of electric motors 204 is also provided with each of the first pair of electric motors 204 being coupled to a respective one of the pair of gearbox assemblies 202. The electric motors 204 may be directly coupled to the shredder rotors 58 without use of the gearbox assemblies 202, particularly, when sufficient room exists to use electric motors 204 of larger sizes. The electric motors 204 can be of the type as manufactured by Baldor of Fort Smith, Ark. under a model VL3514. There is also a second pair of electric motors 206, each of the second pair of electric motors 206 being coupled to a respective one of the pair of rotors 180 and being mounted, for example, by fastening, to a support member 208. Each electric motor 206 may be coupled directly to the rotor 180 or through an optional motor coupling 209. The electric motors 206 may be also fastened to the mounting member 72. The electric motors 206 may be of a type as manufactured by Leeson, a subsidiary of Regal-Beloit Corporation of Beloit, Wis., under a model 112136.00.

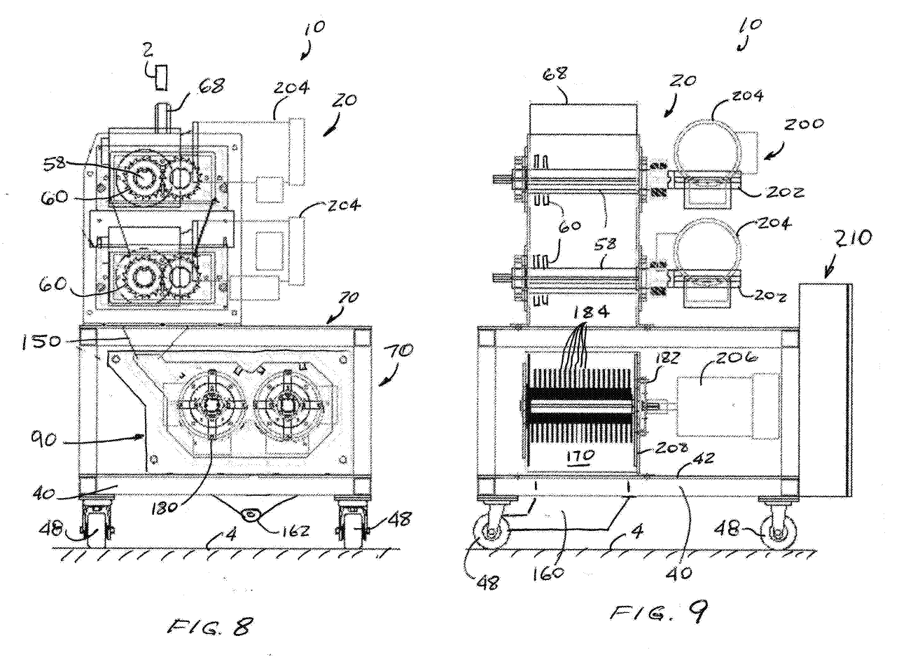

In an embodiment of FIGS. 8-9, the mounting member 30 of the shredder assembly 20 and the mounting member 72 of the hammer mill assembly 70 can be integrated, so that the hammer mill assembly 70 is supported, during use of the apparatus 10, on the mounting member 30, for example when the bottom member 40 is provided as a closed member with the hammer mill assembly 70 being mounted thereon.

When the mounting member 72 is sized and shaped to be received within the mounting member 30 having the bottom member 40 adapted with an opening 42, such bottom member 40 may be provided with one or more ledges 43 positioned to provide additional support for the mounting member 72.

When the hammer mill housing is provided as constructed and configured in FIGS. 4-9, the hammer mill chute 150 is configured to move with the movement or pivoting the upper portions 108, 110, 114 and 116 and top members 136. In this form, an unobstructed access is provided to the hammers 184, as is best illustrated in FIG. 6, when the hammer mill assembly 70 is being moved away or positioned external to the shredder assembly 20. With this unobstructed access, the hammer 184 and the rotors 180 can be removed with a simple, substantially linear motion relative to the lower portions 106, 112, for replacement or maintenance purposes, without the need for any side-to-side movement of the hammer 184 and the rotors 180 during removal process. The installation or reinstallation of the hammer 184 and the rotors 180 is also achieved in such simple substantially linear motion.

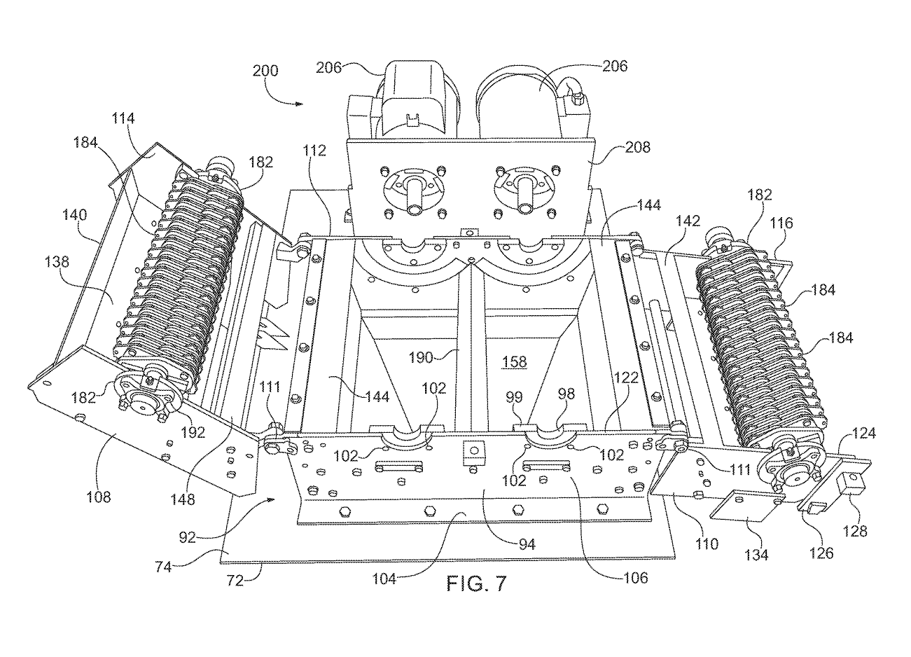

In a further reference to FIG. 7, split design of the mounting provisions for rotors 180 and movable top portions provide for configuration when one or both rotors 180 with hammers 184 thereon can be left affixed, with the upper fasteners 192, to upper portions 108, 110, 114 and 116 and pivoted with such upper portions into the open position of FIGS. 6-7. This form provides even a greater unobstructed access to the hammers 184. This form further provides access to the screens 186, that are not shown in FIG. 7, without complete removal of the hammers 184 and rotors 180.

The pair of opposing upper portions 108 and 114 joined by the member 136 and pair of opposing upper portions 110 and 116 also joined by the member 136 can be also referred to in this document as a top portion, or in reference to the disclosure of FIGS. 3-9, as a top half. Likewise, the pair of lower portions 94, 96 joined by the pair of members 146 can be also referred to in this document as a bottom portion. The bottom portion can be also provided of a unitary, one-piece construction.

Thus, the rotors 180 can be secured, with fasteners 192, to one or both top portions or halves of the hammer mill housing 90 and the lower portions 94, 96, so that one or both rotors 180 and the hammers 184 on the one or both rotors 180 are configured to move with one or both top portions when being secured with the fasteners 192 only to such top portions.

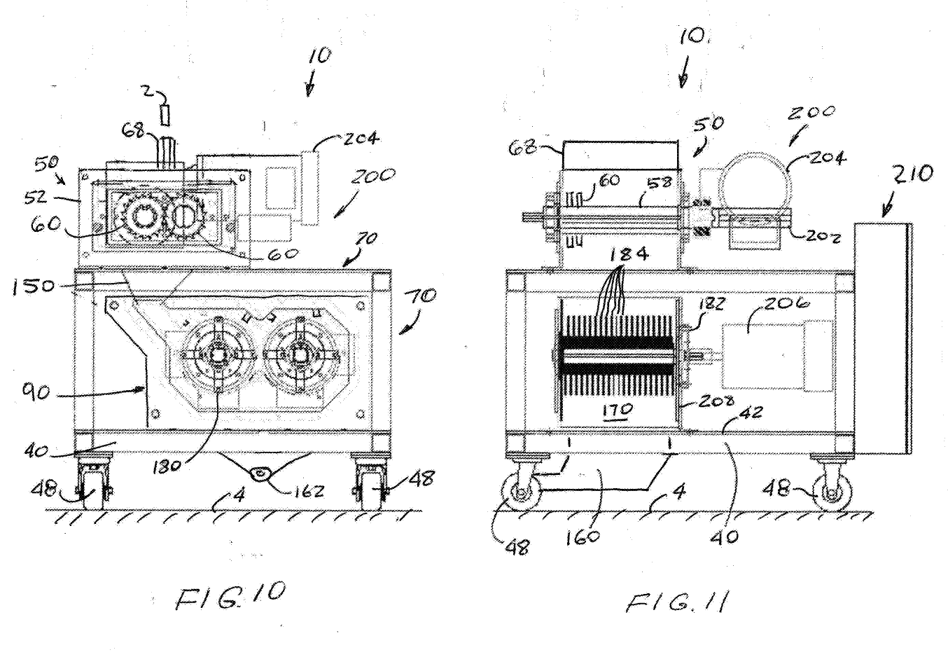

In an embodiment of FIGS. 10-11, the apparatus 10 can be provided as comprising only a single cross-cut shredder assembly 50 with two sets of cutters 60 disposed in a horizontal plane and mounted for rotation on rotors 58 within a housing 52.

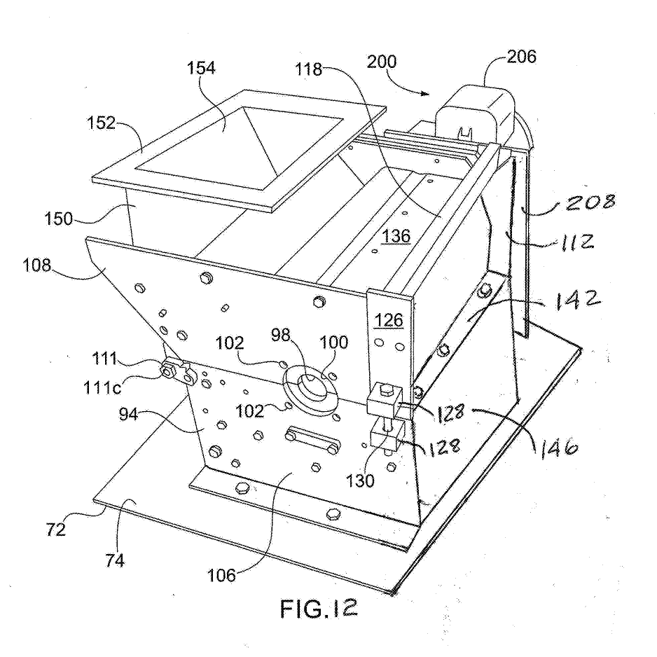

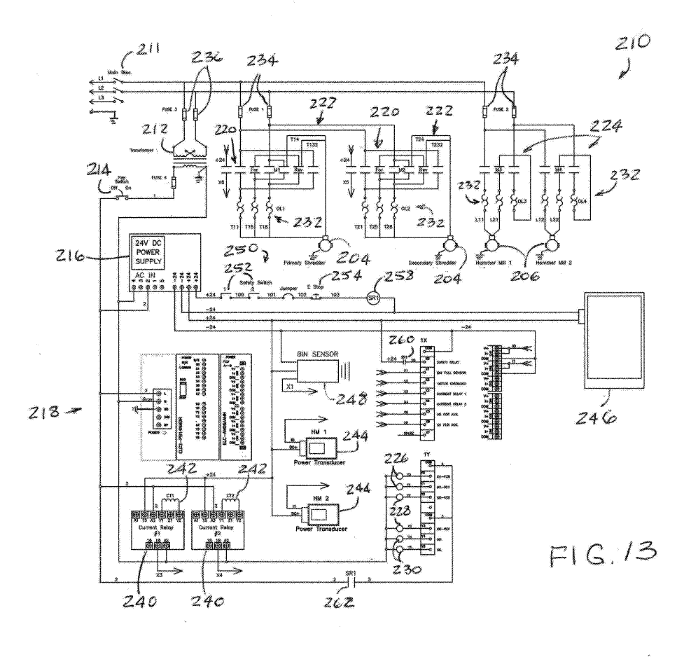

In an embodiment of FIG. 12, the hammer mill assembly 70 can be provided as containing only one set of hammers 184 mounted on a single rotor 180 in single chamber 170. In a further reference to FIGS. 4-7, in this embodiment of FIG. 12, the hammer mill housing 90 can be provided with only a pair of pivots 111, a single top member 136 and chute 150 and utilize members 126, 128 and 130 to prevent an unintended separation of the top portion from the lower portion. In a further reference to FIG. 4, the pair of pivots can be located on the left side of the hammer mill housing 90 with the hammer mill housing 92 being shortened from right to left and the right member 146 defining the right wall of the smaller hammer mill housing 92. In this embodiment, the handle 132 may or may not be provided. If the handle 132 is not provided, the upper flange 152 of the chute 150 may be used for pivoting a single top portion.

The exemplary control assembly 210 is illustrated in FIG. 13, as comprising a main disconnect switch 211, a transformer 212, an ON/OFF switch 214, a AC-DC converter 216 coupled to the transformer 214 and a control unit 218. In one form, the control unit 218 comprises programmable logic device(s) and could be of an ELC2-PB14NNDR and ELC-AN06AANN model types as manufactured under Cutler-Hammer brand by Eaton Corporation, headquartered in Dublin, Ireland. In one form, the control unit 218 can be a microprocessor device comprising one or more processors and non-transitory tangible computer readable medium and/or tangible computational medium comprising algorithms and/or executable instructions, that cause the one or more processors to at least energize and deenergize shredder assembly 20 and the hammer mill assembly 70. In this form, the executable instructions are stored in a non-transitory storage medium within the control unit 218 that can be provided as a computer, a portable device that includes, but is not limited to, a cell phone, a smart phone, a portable personal computer, a pad, or the like. In this form, tangible computer readable medium means any physical object or computer element that can store and/or execute computer instructions. Examples of tangible computer readable medium include, but not limited to, a compact disc (CD), digital versatile disc (DVD), blu-ray disc (BD), usb floppy drive, floppy disk, random access memory (RAM), read-only memory (ROM), erasable programmable read-only memory (EPROM), optical fiber, etc. It should be noted that the tangible computer readable medium may even be paper or other suitable medium in which the instructions can be electronically captured, such as optical scanning. Where optical scanning occurs, the instructions may be compiled, interpreted, or otherwise processed in a suitable manner, if necessary, and then stored in computer memory.

Alternatively, it may be a plugin or part of a software code that can be included in, or downloaded and installed into a computer application. As a plugin, it may be embeddable in any kind of computer document, such as a webpage, word document, pdf file, mp3 file, etc.

In an embodiment, each electric motor 204 is electrically coupled to contacts of a pair of 3-pole contactors 220 and 222, whose operation is controlled by the control unit 218. One of the pair of contactors, referenced with numeral 220 in FIG. 8, is provided to control rotation of the shaft of the motor 204 in a forward direction. The other one of the pair of contactors, referenced with numeral 222 in FIG. 8, is provided to control rotation of the shaft of the motor 204 in a reverse direction.

Coils 226, 228 and 230 of the respective contactors 220, 222 and 224 are coupled to the control unit 218. Contactors 220, 222 and 224 can be of DILM15-10 model type as manufactured under Cutler-Hammer brand by Eaton Corporation, headquartered in Dublin, Ireland. Operation of each electric motor 204, 206 may be protected with an optional thermal overload member 232 and/or fuses 234. Another fuse(s) 236 may be employed for protection of the transformer 212.

Contactor coils 226, 228 for each electric motor 204 may be controlled from the control unit 218 either directly or through a relay 240. The relay 240 can be of DIB01CB235A model type as manufactured under Cutler-Hammer brand by Eaton Corporation, headquartered in Dublin, Ireland. Furthermore, the control assembly 210 contemplates use of current measuring members or transducers 242 to control operation of each electric motor 204, where each current measuring member 242 electrically couples to a respective relay 240 and is configured to receive a motor wire therethrough.

Another pair of current measuring members or transducers 244 can be employed within the control circuit 210 to measure current consumption by each electric motor 206. Current transducers can be of a type as manufactured by Carlo Gavazzi of Milan, Italy under A82-2050 model.

A user interface 246 can be also provided. The user interface 246 can comprise a control panel with switches and indicators operable or viewable from an exterior surface thereof. The user interface 246 can be also provided as touch screen or a human machine interface member. When the user interface 246 is provided as the touch screen, it can be of a HMIVU07CUNBE model type as manufactured under Cutler-Hammer brand by Eaton Corporation, headquartered in Dublin, Ireland.

An optional sensor 248 may be provided to interface with remnant particle evacuation device (not shown).

A safety circuit 250 may be also provided, comprising one or more safety switches 252 coupled to a source of DC voltage from the AC-DC converter 216, an emergency switch 254 mounted in series with the safety switch 252, and a safety relay having a coil 258 thereof mounted in series with the emergency switch 254 and having a first normally open contact 260 coupled to the user interface 246 so as to display the activation of the safety circuit 250 and a second normally open contact 262 mounted in a path to remove power from the outputs of the control unit 218.

In an embodiment, the control assembly 210 is configured to stop or reverse operation of one or both cross-cut shredders 50 when an overcurrent condition is measured, for example when jamming condition is present, by the motor current monitoring member(s) 242 and such overcurrent condition is communicated to the control unit 218. An over current condition could be a condition when the current draw or consumption measurement from the motor current monitoring member 250 exceeds a predetermined threshold stored within the control unit 218.

In an embodiment, the control assembly 210 is configured to stop or reverse operation of one or both cross-cut shredders 50 when an overcurrent (or current exceeding a threshold value) condition is measured by current measuring member 244 at one or both hammer mill assemblies 70, and such overcurrent condition is communicated to the control unit 218.

In an embodiment, the control assembly 210 is configured to operate the upper cross-cut shredder 50 at a lower motor speed than the lower cross-cut shredder 50 so as to at least prevent a jamming condition thereof.

In an embodiment, both the shredder assembly 20 and the hammer mill assembly 70 can be provided as stationary members. When both the shredder assembly 20 and the hammer mill assembly 70 are provided as stationary members, the mounting member 72 can be replaced by the top member 32 of the mounting frame member 30.

In an embodiment, the shredder assembly 20 can be provided as a stationary member and the hammer mill assembly 70 can be provided as a movable member. In this embodiment, the mounting member 72 is adapted with wheels or casters 86.

In an embodiment, the shredder assembly 20 can be provided as a movable member and the hammer mill assembly 70 can be provided as a stationary member. In this embodiment, the mounting member 30 is adapted with wheels or casters 48.

In an embodiment, the shredder assembly 20 can be configured as comprising cross cut shredders of about 12″ in length (width).

In an embodiment, the shredder assembly 20 can be configured as comprising hammer mill assembly 70 of about 16″ in length (width).

In an embodiment, both the shredder assembly 20 and the hammer mill assembly 70 can be provided as movable members. In this embodiment, the mounting member 30 is adapted with wheels or casters 48 and the mounting member 72 is adapted with wheels or casters 86. When only the hammer mill assembly 70 or both the shredder assembly 20 and the hammer mill assembly 70 are provided as movable members, the mounting member 72 can be sized and shaped to fit within the mounting frame member 30, for example within the opening 42 of the U-shaped bottom member 40.

In an embodiment, the hammer mill assembly 70 can be disposed at a distance or separately from the shredder assembly 20, even during operation of the hammer mill assembly 70. In other words, it is not necessary for the hammer mill assembly 70 to be disposed, in a vertical direction, under the shredder assembly 20. In one form, the hammer mill assembly 70 and the shredder assembly 20 may be located at different ends of a facility tasked with destruction of data storage devices 2. In one form, the hammer mill assembly 70 and the shredder assembly 20 may be even located in a same building but different areas separated by wall structure, different buildings and/or used by different entities. In this form, one entity may perform shredding operation, on any suitable shredding equipment that could be used for shredding other products, for example paper, plastic bottles and the like, as a first phase or stage of the process. Shredded remnants may be then delivered to another entity for the final destruction phase using hammer mill assembly. When the hammer mill assembly 70 is disposed at a distance or separately from the shredder assembly 20, the partially shredded or destroyed data storage devices 2 would be transported from the shredder assembly 20 to the hammer mill assembly 70 either in suitable container(s) or by way of conveyor(s).

In an embodiment, the apparatus 10 is configured and operable to destroy data storage devices 2 without the need for a degaussing action for a complete compliance with NSA requirements so that classified information cannot be recovered when provided in different storage forms, for example such as, paper, tape, CD, DVD, magnetic media, optical media, SSD, etc.

In an embodiment, the apparatus 10 is configured and operable to destroy paper media or documents containing classified or unclassified information thereon. The apparatus 10 can be configured and operable to destroy paper media or documents in accordance with requirements NSA/CSS PM 9-12 Storage Device Sanitization Manual. The apparatus 10 can be configured and operable to destroy paper media or documents to shards measuring five millimeters square or less in area and even one millimeter by five millimeters.

The apparatus 10 can be configured and operable to data storage devices in accordance with NSA/CSS Specification 02-01 for Level 6 security. The apparatus 10 can be configured and operable to data storage devices in accordance with NSA/CSS Specification 02-02. The apparatus 10 can be configured and operable to data storage devices in accordance with NSA/CSS Specification 04-01. The apparatus 10 can be configured and operable to data storage devices in accordance with NSA/CSS Specification 0-02.

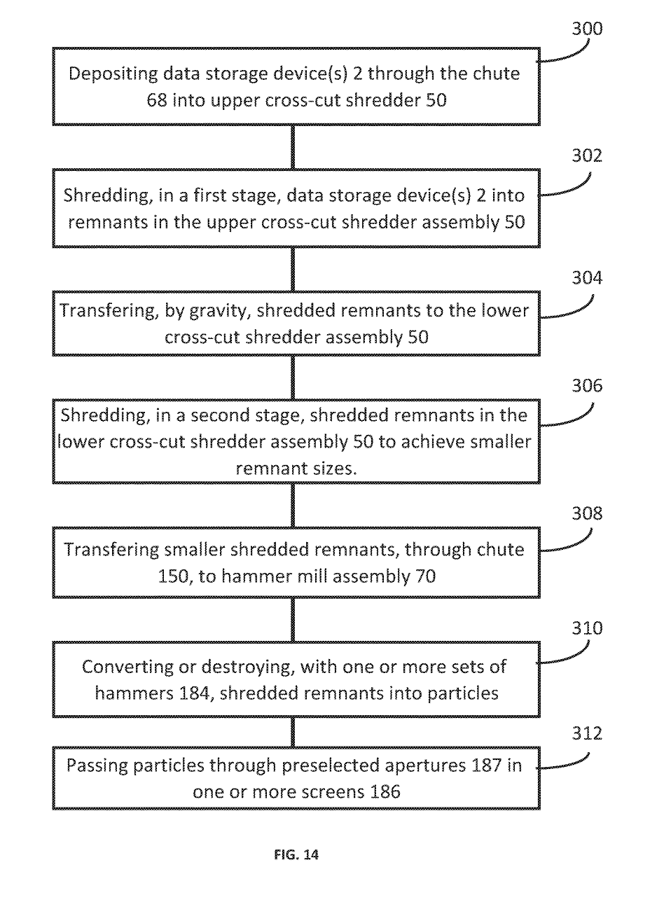

Now in reference to FIG. 14, an exemplary embodiment of a process or method for destroying data storage devices 2 comprises depositing in step 300, through the shredder chute 68, the data storage devices 2 into the shredder assembly 20, shredding, in step 302, the data storage devices 2 in stage one, by a first or upper cross-cut shredder 50 into remnants, transferring in step 304, by gravity, the shredded remnants into the second or lower cross-cut shredder 50, shredding in step 306 shredded remnants by a second or lower cross-cut shredder 50 in stage two, configured to produce smaller sized remnants as compared with remnants produced by the first or upper cross-cut shredder 50, transferring in step 308, the smaller shredded remnants of such data storage devices 2 from the second cross-cut shredder 50 to the hammer mill assembly 70 through the chute 150, converting or destroying, in step 310, the shredded remnants with one or two sets of the rotating hammers 184 in one or two chambers 170 into particles, and discharging or passing, in step 312 particles through preselected apertures 187 in a screen 186 in each of the one or two chambers 170.

In an embodiment, the process or method for destroying data storage devices 2 comprises depositing the data storage device(s) 2 into the shredder assembly 20 through the chute 68, shredding the data storage devices 2 by one cross-cut shredder 50, transferring, by gravity, the shredded remnants of such data storage devices 2, through the chute 150, to the hammer mill assembly 70, converting or destroying the shredded remnants, by hammering with rotating hammers 184, in one or two chambers 170 into particles, and discharging or passing particles through apertures 187 in one or both screens 186.

In an embodiment, the process or method for destroying data storage devices 2 comprises depositing the data storage device(s) 2 into the shredder assembly 20 through the chute 68, shredding the data storage devices 2 by one cross-cut shredder 50, transferring, by gravity, the shredded remnants of such data storage devices 2, through the chute 150, to the hammer mill assembly 70, converting or destroying the shredded remnants, by hammering with rotating hammers 184, in one chamber 170 into particles, and discharging or passing particles through apertures 187 in the screen 186.

In an embodiment, the process or method for destroying data storage devices 2 comprises depositing the data storage device(s) 2 into the shredder assembly 20 through the chute 68, shredding the data storage device(s) 2 in stage one, by a first or upper cross-cut shredder 50 into remnants, transferring, by gravity, the shredded remnants into the second or lower cross-cut shredder 50, shredding shredded remnants by a second or lower cross-cut shredder 50 in stage two, configured to produce smaller sized remnants as compared with remnants produced by the first or upper cross-cut shredder 50, transferring, by gravity, the shredded remnants of such data storage devices 2, through the chute 150, to the hammer mill assembly 70, converting or destroying the shredded remnants, by hammering with rotating hammers 184, in one chamber 170 into particles, and discharging or passing particles through apertures 187 in the screen 186.

In an embodiment, the process or method may comprise shredding data storage devices 2 in stage one into a size of about 0.25″ wide by about 1″ long, shredding data storage devices 2 in stage two into a size of about 0.25″ wide by about 0.25″ long and hammering shredded remnants after stage two with rotating hammers 184 to achieve a final particle size of 2 mm or less using the screen 186 with round apertures 187 having diameter of about 0.065″ and being spaced apart from each other in an orthogonal grid configuration at a distance of about 0.096″ from each other. The process or method may comprise hammering shredded remnants after stage two with rotating hammers 184 to achieve a sand-like final particle size. The process or method may further comprise vacuuming particles of 2 mm or less into a discharge container.

In an embodiment, the process or method may comprise increasing volume of data storage devices 2 to be destroyed by increasing surface of the screen 186 by providing a dual hammer mill assembly 70.

In an embodiment, the process or method may comprise adapting or configuring the apparatus 10 current draw monitoring member(s) 242 and stopping and even reversing the one or more cross-cut shredder(s) 50, with the control assembly 210, when the measured current draw exceeds a predefined or preselected current threshold.

In an embodiment, the process or method may comprise providing a dual hammer mill assembly, mounting two sets of hammers 184 on rotating rotors 180 in a horizontal relationship with each other within and providing a passage between each chamber 170.

In an embodiment, the process or method may comprise adapting the apparatus 10 with current measuring member(s) 244, measuring, with the current measuring member(s) 244, current consumption by one or more hammer mill assemblies 70 and operating, with the control assembly 210, cross-cut shredder(s) 50 in a ON/OFF manner based on the current consumption measured by the current measuring member(s) 244.

In an embodiment, the process or method may comprise mounting the shredder assembly 20 directly above the hammer mill assembly 70 and providing a hollow chute 150 to transfer the shredded remnants of the data storage devices 2 into chamber(s) 170 of the jammer mill assembly 70.

In an embodiment, the process or method may comprise mounting the shredder assembly 20 remotely or at a distance from the hammer mill assembly 70 and transporting shredded remnants of the data storage devices 2 from the shredder assembly 20 to the hammer mill assembly 70.

In an embodiment, the process or method may comprise adapting the hammer mill assembly 70 with wheels or casters 86 and moving the hammer mill assembly 70 in a relationship to the shredder assembly 20.

In an embodiment, the process or method may comprise adapting the shredder assembly 20 with wheels or casters 48 and moving the shredder assembly 20 in a relationship to the hammer mill assembly 70.

In an embodiment, the process or method may comprise adapting the shredder assembly 20 with wheels or casters 48 and adapting the hammer mill assembly 70 with casters or wheels 84. The method may also comprise moving the shredder assembly 20 and the hammer mill assembly 70 relative to one another.

In an embodiment, the process or method may comprise disrupting flow of particles within the chamber(s) 170 by way of baffles or breaker bars 188 mounted on the interior surface(s) of the chamber(s) 170.

In an embodiment, the process or method may comprise mounting the shredder assembly 20 and the hammer mill assembly 70 in a movable relationship with one another.

In an embodiment, the process or method may comprise configuring a housing of the hammer mill assembly 70 with a stationary lower portion and movable upper portion(s).

The chosen exemplary embodiments of the claimed subject matter have been described and illustrated, to plan and/or cross section illustrations that are schematic illustrations of idealized embodiments, for practical purposes so as to enable any person skilled in the art to which it pertains to make and use the same. As such, variations from the shapes of the illustrations as a result, for example, of manufacturing techniques and/or to tolerances, are to be expected. It is therefore intended that all matters in the foregoing description and shown in the accompanying drawings be interpreted as illustrative and not in a limiting sense. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims. It will be understood that variations, modifications, equivalents and substitutions for components of the specifically described exemplary embodiments of the invention may be made by those skilled in the art without departing from the spirit and scope of the invention as set forth in the appended claims.

As used herein, the terms “adapted” and “configured” mean that the element, component, or other subject matter is designed and/or intended to perform a given function. Thus, the use of the terms “adapted” and “configured” should not be construed to mean that a given element, component, or other subject matter is simply “capable of” performing a given function but that the element, component, and/or other subject matter is specifically selected, created, implemented, utilized, programmed, and/or designed for the purpose of performing the function. It is also within the scope of the present disclosure that elements, components, and/or other recited subject matter that is recited as being adapted to perform a particular function may additionally or alternatively be described as being configured to perform that function, and vice versa. Similarly, subject matter that is recited as being configured to perform a particular function may additionally or alternatively be described as being operative to perform that function.

As used herein, the term “coupled” includes direct and indirect connections. Moreover, where first and second devices are coupled, intervening devices including active devices may be located there between.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer, or section from another element, component, region, layer or section. Thus, “a first element,” “component,” “region,” “layer,” or “section” discussed below could be termed a second element, component, region, layer, or section without departing from the teachings herein.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Any element in a claim that does not explicitly state “means for” performing a specified function, or “step for” performing a specified function, is not to be interpreted as a “means” or “step” clause as specified in 35 U.S.C. §112, ¶6. In particular, any use of “step of” in the claims is not intended to invoke the provision of 35 U.S.C. §112, ¶6.

Unless otherwise indicated, all numbers expressing quantities of elements, optical characteristic properties, and so forth used in the specification and claims are to be understood as being modified in all instances by the term “about.” Accordingly, unless indicated to the contrary, the numerical parameters set forth in the preceding specification and attached claims are approximations that can vary depending upon the desired properties sought to be obtained by those skilled in the art utilizing the teachings of the present invention. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the invention are approximations, the numerical values set forth in the specific examples are reported as precisely as possible.

Any numerical value, however, inherently contains certain errors necessarily resulting from the standard deviations found in their respective testing measurements.

The recitation of numerical ranges by endpoints includes all numbers subsumed within that range (e.g. 0.25 to 31 includes 0.26, 0.27, 0.28, 0.29, and 0.30).

Anywhere the term “comprising” is used, embodiments and components “consisting essentially of” and “consisting of” are expressly disclosed and described herein.”

Furthermore, the Abstract is not intended to be limiting as to the scope of the claimed invention and is for the purpose of quickly determining the nature of the claimed invention.

What is claim is:

1. An apparatus configured to destroy data storage devices, comprising:
a hammer mill assembly comprising:
a mounting member,
a hammer mill housing upstanding on said mounting member and comprising a top wall, a bottom wall, and four side walls,
a pair of chambers formed by a combination of said top wall, said bottom wall, and said four side walls, each of said pair of chambers having opposing elongated curved portions defined in said bottom wall and tapered portions defined in said top wall, said curved portions and said tapered portions spanning a distance between two opposing side walls and defining a passageway from one chamber to another,
a pair of rotors, each of said air of rotors disposed within a respective one of said pair of chambers and having ends thereof mounted for a rotation in said opposing side walls of said hammer mill housing,
hammers mounted on said each of said pair of rotors, at least some of said hammers being pivotally mounted, ends of said hammers, when extended or fixed during rotation, describing a circle of a predetermined radius for said each of said first and second rotors,
a pair of screens, each of said pair of screens disposed, between said opposing side walls in said bottom wall of said hammer mill housing, in an alignment with a respective one of said pair of rotors,
baffles spanning said distance between said opposing side walls and disposed in a spaced apart relationship with each other on an interior surfaces of said top and bottom of each of said pair of chambers, and
a hammer mill chute extending from said top wall and having one end thereof in an open communication with one of said pair of chambers;
a shredder assembly comprising:
a mounting member,
a pair of cross-cut shredders mounted in a vertical tandem arrangement with one another, each of said pair of shredders comprising:
a shredder housing,
a pair of shredder rotors mounted in tandem with one another and for a rotation within said shredder housing,
cutters mounted on each of said pair of shredder rotors for said rotation therewith, said cutters overlapping one another during said rotation,
a passageway defined between shredder housings in an open communication therewith,
a bottom shredder housing being configured and mounted in an open communication with said hammer mill chute, and
a shredder chute disposed on an upper shredder housing in an open communication thereof;
a power drive assembly, comprising:
a pair of gearbox assemblies, each coupled to one of said pair of cross-cut shredders,
a first pair of electric motors, each of said first pair of electric motors coupled to a respective one of said pair of gearbox assemblies, and
a second pair of electric motors, each of said second pair of electric motors coupled to a respective one of said pair of rotors within said hammer mill assembly; and
a control assembly, comprising:
a transformer,
an ON/OFF switch,
a AC-DC converter coupled to said transformer,
a control unit comprising programmable logic device(s),
motor contactors, each having a coil thereof coupled to said control unit and having contacts thereof mounted in a circuit between source of electric energy and a respective electric motor,
a pair of relays, each of said pair of relays having a connection with said control unit and a connection with said respective motor of said first pair of motors,
a first pair of motor current measuring members, each of said first pair of motor current monitoring members coupled to a respective one of said pair of relays and configured to measure current consumption at one from said first pair of electric motors,
a second pair of motor current measuring members, each of said second pair of motor current monitoring members coupled to said control unit and configured to measure current consumption at one from said second pair of electric motors,
a user interface comprising at least a touch screen,
fuses coupled to protect said transformer and each motor from an overcurrent condition, and
a safety circuit comprising a safety switch coupled to a source of DC voltage from said AC-DC converter, an emergency switch mounted in series with said safety switch, and a safety relay having a coil thereof mounted in series with said emergency switch and having a first normally open contact thereof mounted an operable to display actuation of said safety circuit on said touch screen and a second normally open contact mounted and operable, during said actuation of said safety circuit, to disconnect power from control units outputs.

2. An apparatus configured to destroy data storage devices, comprising:
a shredder assembly;
a hammer mill assembly;
a chute mounted in an open communication with an interior of said shredder assembly and with an interior of said hammer mill assembly, said chute sized and shaped to transfer shredded remnants from said shredder assembly into said hammer mill assembly;
a power drive assembly coupled to each of said shredder assembly and said hammer mill assembly; and
a control assembly configured to operate said shredder assembly and said hammer mill assembly.

3. The apparatus of claim 2, further comprising baffles mounted within chamber(s) of said hammer mill assembly and configured to disrupt flow of remnants of the data storage devices being destroyed therewithin;

4. The apparatus of claim 2, wherein said shredder assembly comprises:
a mounting member; and
a pair of shredders mounted in a vertical tandem arrangement with one another, each of said pair of shredders comprising:
a shredder housing,
a pair of shredder rotors mounted in tandem with one another and for a rotation within said shredder housing,
cutters mounted on each of said pair of shredder rotors for said rotation therewith, said cutters overlapping one another during said rotation,
a passageway defined between shredder housings in an open communication therewith,
a bottom shredder housing being configured and mounted in an open communication with said hammer mill chute, and
a shredder chute disposed on an upper shredder housing in an open communication thereof.

5. The apparatus of claim 2, wherein said hammer mill assembly comprises:
a mounting member;
a hammer mill housing upstanding on said mounting member and comprising a top wall, a bottom wall, and four side walls;
a pair of chambers formed by a combination of said top wall, said bottom wall, and said four side walls, each of said pair of chambers having opposing elongated curved portions defined in said bottom wall and tapered portions defined in said top wall, said curved portions and said tapered portions spanning a distance between two opposing walls and defining a passageway from one chamber to another chamber;
a pair of rotors, each of said pair of rotors disposed within a respective one of said pair of chambers and having ends thereof mounted for a rotation in said opposing side walls of said hammer mill housing;
hammers mounted on said each of said pair of rotors, at least some of said hammers being pivotally mounted ends of said hammers, when extended or fixed during rotation, describing a circle of a predetermined radius for said each of said first and second rotors;
a pair of screens, each of said pair of screens disposed, between said opposing side walls in said bottom wall of said hammer mill housing, in an alignment with a respective one of said pair of rotors;
baffles spanning said distance between said opposing side walls and disposed in a spaced apart relationship with each other on an interior surfaces of said top and bottom of each of said pair of chambers; and
a hammer mill chute extending from said top wall and having one end thereof in an open communication with one of said pair of chambers.

6. The apparatus of claim 5, wherein said hammer mill assembly comprises:
a mounting member;
a hammer mill housing upstanding on said mounting member and comprising a bottom portion mounted stationary on a mounting member of said hammer mill assembly, and a pair of top portions, each of said pair of upper portions connected, with a pivot, to one end of said lower portion, said each of said pair of upper portions movable between a closed position being in a contact with said lower portion and being juxtaposed with each other to define one or more chambers of said hammer mill housing and an open position being pivoted outwardly and exposing said one or more chambers;
a pair of rotors, each of said pair of rotors disposed within a respective one of said pair of chambers and having ends thereof mounted for a rotation in said opposing side walls of said hammer mill housing;
hammers mounted on said each of said pair of rotors, at least some of said hammers being pivotally mounted, ends of said hammers, when extended or fixed during rotation, describing a circle of a predetermined radius for said each of said first and second rotors;
a pair of screens, each of said pair of screens disposed, between said opposing side walls in said bottom wall of said hammer mill housing, in an alignment with a respective one of said pair of rotors;
baffles spanning said distance between said opposing side walls and disposed in a spaced apart relationship with each other on an interior surfaces of said top and bottom of each of said pair of chambers; and
a hammer mill chute extending from said top wall and having one end thereof in an open communication with one of said pair of chambers.

7. The apparatus of claim 6, wherein each of said pair of rotors is secured, with fasteners, to said pair of top portions and said bottom portion, one or both of said pair of rotors and said hammers are configured to move with one or both of said pair of top portions when being secured with said fasteners only to said one or both of said pair of top portions.

8. The apparatus of claim 2, wherein said power drive assembly comprises:
a pair of gearbox assemblies, each coupled to a rotor in one of said pair of cross-cut shredders;
a first pair of electric motors, each of said first pair of electric motors coupled to a respective one of said pair of gearbox assemblies; and
a second pair of electric motors, each of said second pair of electric motors coupled to a respective one of said pair of rotors within said hammer mill assembly.

9. The apparatus of claim 2, wherein said control assembly comprises:
a transformer,
an ON/OFF switch,
a AC-DC converter coupled to said transformer,
a control unit comprising programmable logic device(s),
motor contactors, each having a coil thereof coupled to said control unit and having contacts thereof mounted in a circuit between source of electric energy and a respective electric motor,
a pair of motor current monitoring members, each of said pair of motor current monitoring members coupled to said AC-DC converter and to a wire from a respective motor of said first pair of motors and having an output connection coupled to said control unit,
a pair of relays, each of said pair of relays having a connection with said control unit and a connection with said respective motor of said first pair of motors,
a user interface comprising a touch screen,
fuses coupled to protect said transformer and each motor from an overcurrent condition, and
a safety circuit comprising a safety switch coupled to a source of DC voltage from said AC-DC converter, an emergency switch mounted in series with said safety switch, and a safety relay having a coil thereof mounted in series with said emergency switch and having a first normally open contact thereof mounted an operable to display actuation of said safety circuit on said touch screen and a second normally open contact mounted and operable, during said actuation of said safety circuit, to disconnect power from control units outputs.

10. The apparatus of claim 2, wherein said shredder assembly comprises a shredder mounting member, wherein said hammer mill assembly comprises a hammer mill mounting member sized and shaped to be received within confines of said shredder mounting member.

11. The apparatus of claim 2, wherein each of said shredder mounting member and said hammer mill mounting member is adapted with wheels.

12. The apparatus of claim 2, wherein said shredder assembly and said hammer mill assembly are mounted on a single mounting member.

13. The apparatus of claim 2, wherein said shredder assembly comprises a shredder mounting member disposed stationary during use of said apparatus and wherein said hammer mill assembly comprises a hammer mill mounting member sized and shaped to be received within confines of said shredder mounting member and adapted with wheels for movement relative to thereto.

14. The apparatus of claim 2, wherein said shredder assembly comprises a single cross-cut shredder and wherein said hammer mill assembly comprises a single chamber with a rotor and hammers mounted therewithin.

15. The apparatus of claim 2, wherein said shredder assembly comprises a pair of cross-cut shredders and wherein said hammer mill assembly comprises a single chamber with a rotor and hammers mounted therewithin.

16. The apparatus of claim 2, wherein said shredder assembly comprises a single cross-cut shredder and wherein said hammer mill assembly comprises a pair of chambers with a rotor and hammers mounted within each chamber.

17. The apparatus of claim 2, wherein said shredder assembly and said hammer mill assembly are disposed remotely form each other to destroy the data storage devices.

18. The apparatus of claim 2, wherein said shredder assembly and said hammer mill assembly are configured to destroy the digital media storage devices into particles of 2 mm or less in size.

19. A method for destroying data storage devices, comprising:
depositing said data storage devices into a shredder assembly;
shredding, by one or two cross-cut shredders, said data storage devices;
transferring shredded remnants of said data storage devices to a hammer mill assembly,
converting said shredded remnants, with hammers rotating within chamber(s) of said hammer mill assembly, into particles of 2 mm or less in size; and
discharging said particles through apertures in one or more screens.

20. The method of claim 19, further comprising mounting one or more baffles within said chamber(s) and disrupting or agitating, with said one or more baffles, flow of said shredded remnants.
